(19) United States
(12) Patent Application Publication
(10) Pub. No.: US 2026/0131514 A1
(43) Pub. Date: May 14, 2026

(54) A MULTIPLE LAYER MATERIAL, PACKAGING MATERIAL COMPRISING SUCH MULTIPLE LAYER MATERIAL, AND PROCESS FOR PRODUCING A MULTIPLE LAYER MATERIAL

(71) Applicant: Wellplast AB, ÅSTORP (SE)

(72) Inventor: Anders Jönzon, RÅÅ (SE)

(21) Appl. No.: 18/946,682

(22) Filed: Nov. 13, 2024

(51) Int. Cl. B29C 48/00; B29C 37/00; B29C 48/08; B29C 48/22; B29K 23/00; B29K 67/00; B29K 105/08; B29L 7/00; B29L 31/00

(52) U.S. Cl. CPC B29C 48/0021; B29C 37/0053; B29C 37/0082; B29C 48/0014; B29C 48/08; B29C 48/22; B29C 2037/0042; B29K 2023/06; B29K 2023/12; B29K 2067/00; B29K 2105/0854; B29K 2995/001; B29K 2995/0081; B29K 2995/0097; B29L 2007/00; B29L 2031/712

(57) ABSTRACT

A multiple layer material (11) comprising an extruded profile (27) and at least one lamination material (28, 29) adhered to at least one surface (32, 33) of the extruded profile (27) to form the multiple layer material (11). The lamination material (28, 29) is formed with a structure with indentations (48), and the multiple layer material (11) comprises a melt bond and a mechanical bond (41) between the extruded profile (27) and the lamination material (28, 29), wherein said melt bond is formed by at least partially melting the material of the surface (32, 33) of the extruded profile (27) and at least partially melting only a part of the thickness of the lamination material (28, 29), wherein said mechanical bond (41) is formed by that the material at the at least partially melted surface (32, 33) of the extruded profile (27) is brought into the indentations of the lamination material (28, 29), and wherein the lamination material, at least before it is adhered to the extruded profile, is permeable to air. Disclosed is also a process for producing the multiple layer material.

### FIELD OF THE INVENTION

The invention relates to a multiple layer material and a process for continuously producing such a multiple layer material. More specifically the invention relates to a multiple layer material comprising an extruded profile and at least one lamination material, wherein the extruded profile contains a polymer material and the lamination material is adhered to one or both of the top and bottom surfaces of the extruded profile.

Multiple layer materials of this type are generally used as packaging material to protect different kinds of goods during transport and handling. Multiple layer materials of this type can also be used within packaging industry for manufacturing packages containing a variety of different kinds of goods. The invention also relates to a packaging material comprising the multiple layer material. Alternatively, such multiple layer materials can also be used for construction materials for building structures and vehicles, such as wall, floor, roof and ceiling elements, and other types of structures.

### PRIOR ART

There is a plurality of different types of single and multiple layer materials and processes for producing it in the prior art. One such type of process comprises extruding a sheet of polymer material, which extruded sheet is coated with one or more lamination layers of, e.g. plastic materials. Different types of lamination techniques are known. For example, it is known to co-extrude different sheets to obtain a multiple layer material. It is also known to extrude a sheet or a profile and then adhere lamination sheets to said extruded sheet by means of a melt bond or an adhesive. It is also known that such adhered lamination sheets can be composed with a soft and smooth surface making it useful as packaging material, for example for scratch sensitive products.

However, there is a need to provide multiple layer materials and packaging materials with high strength and favourable properties, such as different fabourable surface properties. There is also a need to provide an efficient process for producing such a multiple layer material.

Hence, one problem with prior art multiple layer materials and packaging material made therefrom is that they can damage goods coming into contact with the multiple layer material during transport.

Another problem with such prior art multiple layer materials is that they can lack in strength and tear relatively easy.

Another problem with such prior art multiple layer materials is that they can lack in flexibility and can be relatively difficult to fold into the desired shape without breaking or delaminating.

Another problem with such prior art multiple layer materials is that they can be difficult to handle or have an increased risk of delaminating during certain types of handling.

Another problem with such prior art multiple layer materials is that they can have limitations such that different favourable material and surface properties can not be combined.

### SUMMARY OF THE INVENTION

An object of the invention is to provide multiple layer materials having favourable properties. It is also an object of the invention to provide packaging materials comprising such multiple layer materials. According to the invention a durable multiple layer material with high tear-strength and the possibility to provide favourable surface properties and flexibility is achieved. Further, a process is provided for production of said multiple layer material.

The present invention relates to a multiple layer material comprising an extruded profile and at least one lamination material, wherein the extruded profile comprises at least one polymer material and is formed with a top surface and a bottom surface, wherein the lamination material is adhered to at least one of the top and bottom surfaces of the extruded profile to form the multiple layer material, characterised in that the lamination material is formed with a structure with indentations, and the multiple layer material comprises a melt bond and a mechanical bond between the extruded profile and the lamination material, wherein said melt bond is formed by at least partially melting the material of the surface of the extruded profile and at least partially melting only a part of the thickness of the lamination material, wherein said mechanical bond is formed by that the material at the at least partially melted surface of the extruded profile is brought into the indentations of the lamination material, and wherein the lamination material, at least before it is adhered to the extruded profile, is permeable to air. The combination of the indentations and the air permeability of the lamination material result in a strong and durable lamination material having a plurality of favourable properties. The structure of the lamination material with the indentations and the air permeability result in a favourable combination of melt bond and mechanical bond and the possibility to provide a durable multiple layer material with high tear-strength. The melt bond and the mechanical bond can be formed directly by the extruded profile and the lamination material. Hence, a multiple layer material having favourable properties can be formed without any additional adhesive, such as glue or similar, in a fast and efficient manner. The extruded profile can be formed with longitudinally extending internal cavities. The lamination material is laminated to the extruded profile. The lamination material is not coextruded with the extruded profile. For example, the lamination material is a material which is not coextrudable with the extruded profile. For example, the lamination material is a non-coextrudable material. For example, the lamination material comprises a material structure that cannot be coextruded as an outer layer together with the extruded profile by means of a multicomponent extrusion die.

The extruded profile may comprise a volatile corrosion inhibitor (VCI). Advantageously, the VCI vapours from the outer surface of the profile, creating a rust-protective atmosphere in the vicinity of said surface. This protects metal objects located in the vicinity of said surface from corrosion.

The lamination material can be a nonwoven fabric comprising a thermoplastic polymer. Surprisingly, it has been found that nonwoven fabrics of thermoplastic materials can form a strong bond to an extruded profile by lamination. It is believed that the combination of the melt bond and mechanical bond through the indentations in the inherent irregular structure of the nonwoven fabric result in a strong bond as the melted surface material of the extruded profile is brought into the indentations of the lamination material while melting a part of the thickness of the lamination material. Hence, a multiple layer material with favourable properties and a soft and smooth surface can be provided which is useful for packaging materials. For example, such packaging materials can reduce scratching of the goods to be handled while having high tear-strength. For example, the lamination material can be a point bonded nonwoven fabric, wherein also bond points of the material form indentations and contribute to the favourable bonding between the extruded profile and the lamination material while providing favourable surface and strength properties of the multiple layer material thus formed.

The lamination material may comprise electrical static discharge properties. The lamination material may comprise graphite, or by other means have properties to achieve surface electrostatic discharge properties.

The present invention is also related to a packaging material comprising such a multiple layer material.

The present invention also relates to a process for continuously producing a multiple layer material containing at least one polymer material, comprising the steps of
a) by means of an extruder die extruding a profile having a top surface and a bottom surface,
b) feeding the extruded profile from the extruder die towards a calibrator,
c) applying an air permeable lamination material with indentations onto at least one of said top surface and bottom surface of the extruded profile before entering the calibrator, and
d) bringing an at least partially melted surface material of the extruded profile into the indentations of the lamination material, and thereby forming a mechanical bond between the extruded profile and the lamination material, and
e) at least partially melting only a part of the thickness of the lamination material and thereby forming a melt bond between the extruded profile and the lamination material.

Hence, according to the invention an effective process is provided for producing the multiple layer material, wherein the extruded profile, e.g. with internal cavities, can be coated with one or more lamination layers, e.g. provided on rolls, immediately after extrusion, wherein the lamination layers can be adhered to the extruded profile by heat from the extrusion process, and the extruded profile with the lamination materials are calibrated together to form the resulting multiple layer material. Hence, the lamination materials can be fastened to the extruded profile without using any glue or additional adhesive. The extruded profile is formed by extrusion and is then provided with the lamination material by lamination, wherein the multiple layer material is achieved by a combined extrusion and lamination process and not by coextrusion alone. The lamination materials are not coextruded with the extruded profile to form the multiple layer material of the invention. Instead, the lamination material is laminated to the extruded profile. One or more of the lamination materials is a material that cannot be coextruded with the extruded profile. The lamination material is a non-coextrudable and non-extrudable material. The lamination material can be prefabricated and supplied to the extruded profile through one or more lamination material providing means, e.g. including guide elements, such as guide rollers or similar, a lamination material storage, such as a roll or similar.

The extruded profile and the lamination materials can be melted together by heat from the extrusion process or by heat from the extrusion process in combination with additional heating to form the melt bond between the extruded profile and the lamination material. Also, deformation of the extruded profile in combination with irregularities forming the indentations in the lamination material result in a mechanical bond between the extruded profile and the lamination material. Hence, a favourable fastening is achieved between the extruded profile and the lamination materials without using any glue or additional adhesive and in a cost efficient and energy-saving way as heat from the extrusion process can be used to adhere lamination layers, e.g. provided on rolls. The lamination materials can be laminated to the extruded profile while the extruded profile still has the inherent adhering properties of the polymer being in a melted state due to heat from the extrusion process, i.e. before the extruded profile is cooled in the calibrator.

The multiple layer material can be calibrated by a calibrator having fixed calibration plates or rotatable endless belts running over such calibration plates. The calibration can include providing a vacuum between the calibrator and the multiple layer material to pull the multiple layer material towards the calibration plates or the endless belts. Hence, the multiple layer material can be forced towards the calibration plates or the endless belts to prevent the multiple lamination material having the internal cavities from collapsing and for pulling melted material of the extruded profile into the indentations of the lamination material in an efficient manner, e.g. in combination with pressing the lamination material onto the extruded profile, to provide the melt bond and the mechanical bond between the extruded profile and the lamination material in an efficient manner.

Further characteristics and advantages of the present invention will become apparent from the description of the embodiments below, the appended drawings and the dependent claims.

### SHORT DESCRIPTION OF THE DRAWINGS

The invention will now be described more in detail with the aid of embodiment examples and with reference to the appended drawings, in which

FIG. 1 is a schematic side view illustrating a device and a process for continuously producing a multiple layer material according to one embodiment of the present invention, illustrating extrusion of a profile, providing lamination material to the extruded profile through a lamination material providing means, and calibration and output of the multiple layer material,

FIG. 2 is a schematic side view of a part of the device and process according to FIG. 1, illustrating an extruder die of the extruder and application of lamination materials to the extruded profile before entering the calibrator more in detail according to one embodiment,

FIG. 3 is a schematic section view of a part of the view according to FIG. 2, illustrating the extrusion of the extruded profile and the application of the lamination materials to the extruded profile more in detail according to one embodiment,

FIG. 4a is a schematic section view of the extruded profile along the line A-A in FIG. 3 according to one embodiment, illustrating longitudinally extending internal cavities of the extruded material,

FIG. 4b is a schematic section view of the extruded profile along the line A-A in FIG. 3 according to one alternative embodiment,

FIG. 5 is a schematic section view of the extruded profile along the line A-A in FIG. 3 according to one alternative embodiment,

FIG. 6 is a schematic side view of the lamination material according to one embodiment,

FIG. 7 is a schematic enlargement of the lamination material illustrating a surface structure thereof according to one embodiment,

FIG. 8 is a schematic enlargement of the indicated area in FIG. 7,

FIG. 9 is a schematic section view of the multiple layer material along line B-B in FIG. 1 according to one embodiment,

FIG. 10 is a schematic section view of the multiple layer material along line B-B in FIG. 1 according to one alternative embodiment,

FIG. 11 is a schematic section view of a part of the view according to FIG. 3, illustrating the vacuum channels of the calibrator more in detail according to one embodiment,

FIG. 12 is a schematic side view of a part of the device according to another alternative embodiment, wherein the calibrator comprises a pair of endless belts for conducting the multiple layer material,

FIG. 13 is a schematic section view of a part of the view according to FIG. 12, illustrating the extrusion of the extruded profile, application of the lamination materials to the extruded profile and a part of the calibrator more in detail, and

FIG. 14 is a schematic side view of the device according to another alternative embodiment, wherein a part of the extruder is arranged perpendicular to the extruder die and the device comprises a lamination providing means with features for automatic replacement of the lamination materials.

### THE INVENTION

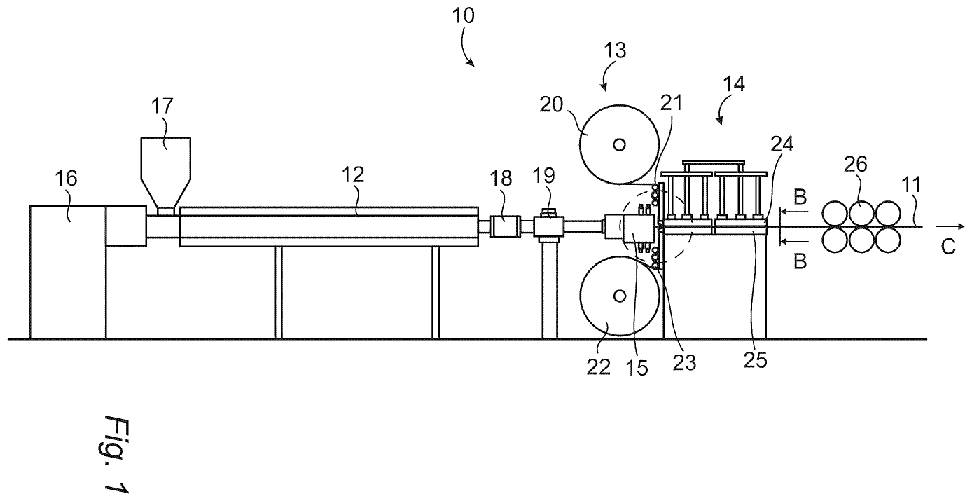

Referring to FIG. 1 a device 10 and a process for continuously producing a multiple layer material 11 is illustrated schematically according to one embodiment. The device 10 and process is arranged for producing a multiple layer material 11 comprising at least one polymer material, such as a plastic material, e.g. in the form of a thermoplastic material, such as a polyolefin. The multiple layer material 11 is, e.g. a packaging material or is used for providing a packaging material for protecting goods during transport and handling or is used for producing packages in the package industry. Alternatively, the multiple layer material 11 is used for forming a construction material for buildings, vehicles and other types of structures. For example, the multiple layer material 11 is used to form wall, floor, roof and ceiling elements.

The device 10 comprises an extruder 12, lamination material providing means 13 and a calibrator 14. The extruder 12 is arranged for extruding a material to provide an extruded profile containing said polymer material, which extruded profile comprises opposite sides, such as a top side and a bottom side and is described in more detail below. The extruder 12 comprises an extruder die 15 for forming the extruded profile. In the illustrated embodiment the extruder 12 comprises a screw operated by a motor 16 for feeding the material to be extruded from a material storage, such as a hopper 17 or similar, to the extruder die 15 through a screen filter 18 and a melt pump 19. According to one embodiment the extruder 12 is a conventional extruder, wherein the material to be extruded is heated in the extruder in a conventional manner.

The lamination material providing means 13 is arranged for providing a lamination material to the extruded profile to form the multiple layer material. The lamination material providing means 13 is arranged for providing the lamination material to the extruded profile before entering the calibrator 14. For example, the lamination material providing means 13 comprises at least one roll for carrying the lamination material and providing it to the extruded profile. In the illustrated embodiment, the lamination material providing means 13 comprises a first lamination material storage roll 20 and first guide rollers 21 for storing and guiding a first lamination material, and a second lamination material storage roll 22 and second guide rollers 23 for storing and guiding a second lamination material. Alternatively, the device 10 comprises a single lamination material storage roll and optional means for guiding the lamination material to the extruded profile.

The calibrator 14 is arranged for cooling and setting the multiple layer material 11 at a predetermined thickness after the extruded profile has been provided with the lamination material or the first and second lamination materials. In the embodiment of FIG. 1 the calibrator 14 comprises a top calibration plate 24 and a bottom calibration plate 25 arranged with a gap between them for receiving the multiple layer material 11. For example, the calibrator 14 is a calibration table, such as a dry calibration table. In the illustrated embodiment the device 10 comprises pulling rollers 26 for pulling the multiple layer material in a feeding direction, which is illustrated by means of the arrow C in FIG. 1. The pulling rollers 26 are arranged for pulling the extruded profile, the lamination material and the multiple layer material 11 in the longitudinal direction, which corresponds to the feeding direction C.

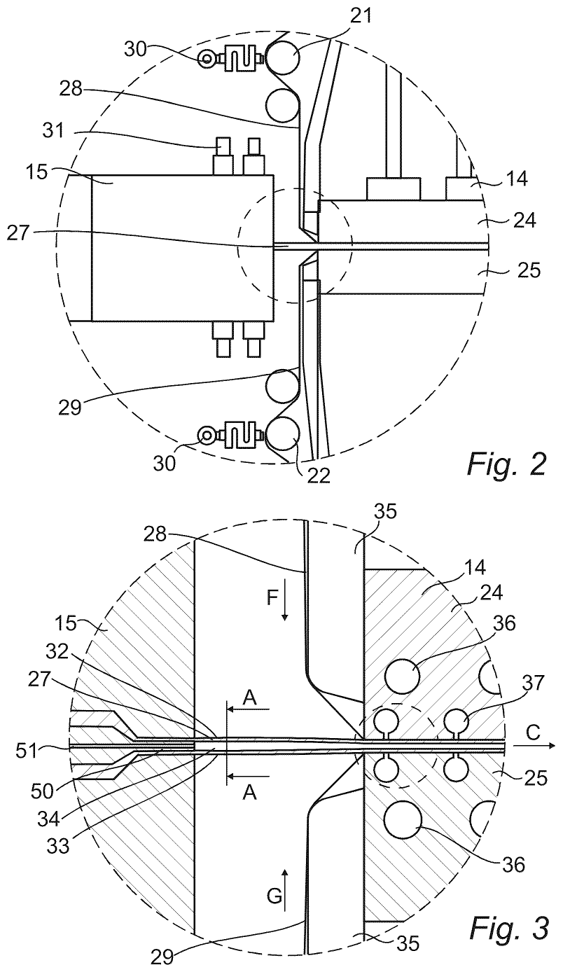

With reference to FIG. 2 a part of the device 10 depicted by the dashed circle in FIG. 1 is illustrated schematically more in detail, wherein the extruded profile is conducted from the extruder die 15 and the lamination material is applied to the extruded profile. The extruded profile is indicated by reference numeral 27, wherein a first lamination material is indicated by reference numeral 28 and an optional second lamination material is indicated by reference numeral 29. In the illustrated embodiment the extruded profile 27 is provided with both the first and second lamination materials 28, 29. According to an alternative embodiment, the extruded profile 27 is provided with a single lamination material.

According to the illustrated embodiment the extruded profile 27 is formed by the extruder die 15 and fed into the calibrator 14 between the top calibration plate 24 and the bottom calibration plate 25. The calibrator 14 is arranged a distance from the extruder die 15 forming a gap between the extruder die 15 and the calibrator 14. The first and second lamination materials 28, 29 are fed through the gap between the extruder die 15 and the calibrator 14 and further into engagement with the extruded profile 27. For example, the lamination materials 28, 29 are guided into the gap between the calibrator 14 and the extruder die 15 by means of the guide rollers 21, 23 or in any other suitable way. For example, the gap between the extruder die 15 and the calibrator 14 is less than 500 mm. In the illustrated embodiment the device 10 comprises web tensioning devices 30 for controlling the tension of the lamination materials 28, 29 being fed to the extruded profile 27. In the embodiment of FIG. 2 the extruder die 15 comprises conventional adjustment screws 31 for adjusting the shape of the extruder die 15 and thus the shape of the extruded profile 27.

With reference to FIG. 3, a part of the device 10 depicted by the dashed circle in the middle of FIG. 2 is illustrated schematically more in detail in one embodiment. The extruded profile 27 is formed with a top surface 32, a bottom surface 33 and longitudinally extending internal cavities 34 by means of the extruder die 15. The extruder die 15 comprises a plurality of core bars 53 arranged to provide the desired shape of the extruded profile 27 and form the internal cavities 34. Air supply channels 51 are arranged inside the core bars 53 to blow air into the internal cavities 34 to prevent the extruded profile 27 from collapsing. For example, air is supplied through the air supply channels 51 to the internal cavities 34 with suitable overpressure so as to force the top and bottom surfaces 32, 33 of the extruded profile 27 in a direction towards the top and bottom calibration plates 24, 25, respectively, when the multiple layer material 11 with the extruded profile 27 is in the calibrator 14. For example, air is supplied through the air supply channels 51 to the internal cavities 34 to expand the extruded profile 27 vertically, i.e. in the direction along the thickness of the extruded profile 27, so that the extruded profile 27 is pressed against the first lamination layer 28 and the optional second lamination layer 29 inside the calibrator 14.

After extrusion, the still warm extruded profile 27 is fed from the extruder die 15 towards the calibrator 14 in the direction of the arrow C passing through the gap between the extruder die 15 and the calibrator 14. In said gap the first lamination material 28 is fed to one of the surfaces of the extruded profile 27, such as the top surface 32, which is illustrated by the arrow F, wherein the second lamination material 29 is fed to the opposite surface of the extruded profile 2, such as the bottom surface 33, which is illustrated by means of the arrow G.

In the illustrated embodiment the lamination materials 28, 29 are conducted over air supply elements 35 having a rounded edge before engaging the extruded profile 27, said air supply elements 35 being arranged for blowing hot or cold air towards the first and/or second lamination materials 28, 29 for heating or cooling thereof if required. Alternatively, the lamination materials 28, 29 are conducted over any optional guide means for guiding the lamination materials 28, 29 to the extruded profile 27 in a suitable manner.

The one or more lamination materials 28, 29 is/are applied on the surface 32, 33 of the extruded profile 27 still being warm by the extrusion process before the extruded profile 27 with the one or more lamination materials 28, 29 enters the calibrator 14 for cooling and setting. For example, the first lamination material 28 is applied on the top surface 32 of the extruded profile 27 still being warm by the extrusion process, wherein the second lamination material 29 is applied on the bottom surface 33 of the extruded profile 27 before the extruded profile 27 with the lamination materials 28, 29 enters the calibrator 14 for cooling and setting. For example, the lamination materials 28, 29 are adhered to the extruded profile 29 at least partially by means of heat from the extrusion process. For example, the top and bottom surfaces 32, 33 of the extruded profile 27 are still melted or softened by heat from the extrusion process when the lamination materials 28, 29 engage the extruded profile 27, wherein the lamination materials 28, 29 adhere to the melted or softened top and bottom surfaces 32, 33 of the extruded profile 27. Hence, the extruded profile 27 is still in an unsolid state. Alternatively, the surface of the lamination materials 28, 29 are melted or softened by extrusion process heat stored in the extruded profile 27, wherein the lamination materials 28, 29 are adhered to the extruded profile 27 by the lamination material surfaces being melted or softened. After the lamination materials 28, 29 have engaged the extruded profile 27 and thus the extruded profile 27 has been provided with the lamination materials 28, 29, the thus provided multiple layer material 11 is fed into the calibrator 14 between the top calibration plate 24 and the bottom calibration plate 25 for cooling and setting the multiple layer material 11. In the illustrated embodiment the calibrator 14 comprises cooling channels 36 for a coolant to cool the multiple layer material 11. For example, the cooling channels 36 are arranged in a conventional manner. In the illustrated embodiment the calibrator 14 comprises vacuum channels 37, which is described in more detail below.

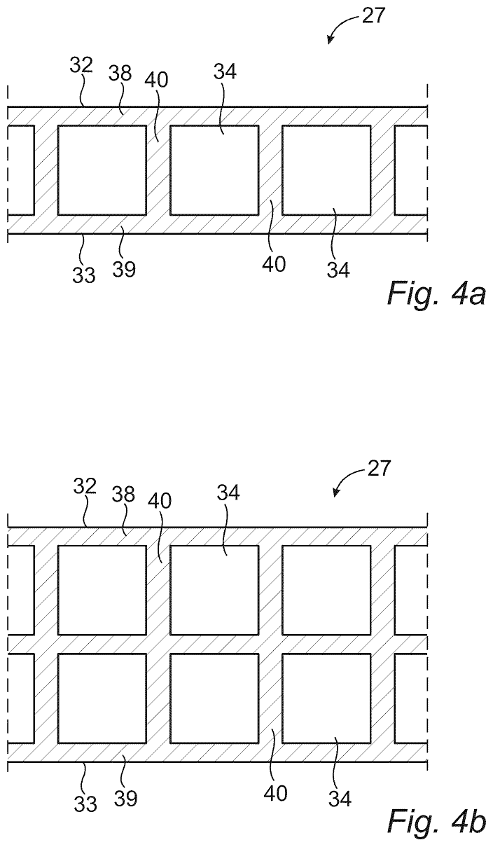

With reference to FIGS. 4 and 5, a section of the extruded profile 27 along the line A-A in FIG. 3 is illustrated schematically according to a few possible examples. The extruded profile 27 comprises a top wall 38 with the top surface 32, a bottom wall 39 with the bottom surface 33, and connecting walls 40 extending between the top and bottom walls 38, 39 to form the internal cavities 34. Hence, the top wall 38 is arranged at a distance from the bottom wall 39 so as to form a gap between them. For example, the top and bottom walls 38, 39 are arranged in parallel to each other. For example, the distance between the top and bottom walls 38, 39 is at least 1 mm, such as 1-50 mm, 1-20 mm or 1-10 mm and for example around 2-5 mm. In the illustrated embodiment, the cavities 34 are arranged between the top and bottom walls 38, 39. For example, the cavities 34 extend along the entire length of the top and bottom walls 38, 39. For example, the extruded profile 27 is extruded continuously, wherein the cavities 34 are formed continuously, so that each cavity is arranged with a length corresponding to the length of the top wall 38, which length also corresponds to the length of the bottom wall 39. The extruded profile 27 comprises a polymer, such as a thermoplastic material. For example, the extruded profile 27 comprises a polyolefin, such as polypropylene. For example, the extruded profile 27 comprises a polyolefin and a volatile corrosion inhibitor agent. The extruded profile 27 is formed in a material that can be melted and exhibits inherent adhering properties in such a melted state. Such a melted state can also be called an unsolidified state. In the embodiment of FIGS. 4a and 4b the connecting walls 40 extend perpendicular to the top and bottom walls 38, 39 to form the cavities 34 with rectangular cross section. In such a case the length of the connecting walls 40 correspond to the distance between the top and bottom walls 38, 39. In the embodiment of FIG. 4a the internal cavities 34 are distributed in the lateral direction of the extruded profile 27 in a single row. In the embodiment of FIG. 4b the extruded profile 27 comprises internal cavities 34 arranged in a plurality of rows, wherein the internal cavities 34 also are distributed in a direction corresponding to the thickness of the extruded profile 27. In the embodiment of FIG. 5 the connecting walls 40 are inclined in relation to the top and bottom walls 38, 39 to form cavities 34 having a triangular cross section. Alternatively, the extruded profile 27 is formed with longitudinally extending cavities having circular, oval or polygonal cross section or in any other suitable way. According to another embodiment, the extruded profile 27 is co-extruded with additional layers on the top and bottom surfaces 32, 33.

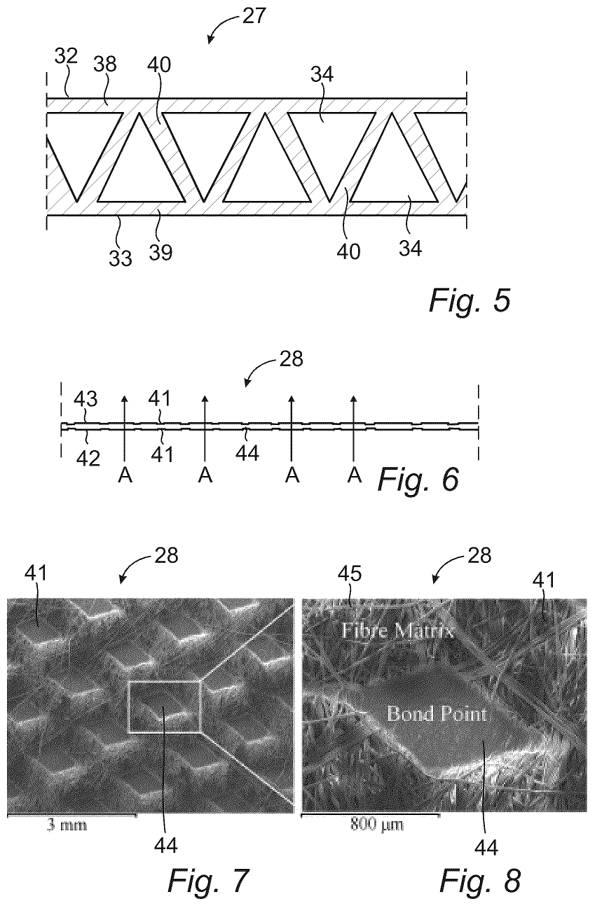

With reference to FIGS. 6-8 the lamination material 28, 29 is illustrated according to some embodiments. The lamination material 28, 29 is a sheet material, such as a flexible sheet material which can be supplied from a storage roll 20, 22. For example, the lamination material 28, 29 is a prefabricated sheet material, which can be produced in a process and location separated from the process and location for producing the multiple layer material 27 according to the present invention. The lamination material 28, 29 has a structure with indentations 41. For example, the lamination material 28, 29 has a surface structure with irregularities, such as inherent irregularities, resulting in the indentations 41. For example, the indentations 41 are of uniform or random size and distribution over one or more of the surfaces of the lamination material 28, 29. The lamination material 28, 29 is permeable to air, which is illustrated schematically in FIG. 6 by means of the arrows A. For example, air and similar fluids can flow from a side at a first surface 42 of the lamination material 28, 29 to the opposite side at the opposite second surface 43 thereof through the lamination material 28, 29, such as substantially perpendicular through it. For example, the lamination material 28, 29 is permeable to air by the inherent structure thereof. Alternatively, the lamination material 28, 29 is permeable to air by holes arranged therein, which is not illustrated in the drawings. The indentations 41 extend into the lamination material 28, 29 from at least one of the surfaces 42, 43 thereof, such as perpendicular from said surface 42, 43. Hence, the indentations 41 extend in a direction perpendicular to a plane of the lamination material 28, 29. However, the indentations 41 are, e.g. irregular and extend also in the plane of the lamination material 28, 29, such that irregular structures and/or pores are formed. Hence, some of the indentations 41 have a smaller opening towards the surface 42, 43 and a wider bottom and/or are split up into a plurality of openings into the lamination material 28, 29.

The lamination material 28, 29 comprises a polymer, such as a thermoplastic material. For example, the lamination material 28, 29 is a polyolefin. For example, the lamination material 28, 29 comprise polypropylene, polyester and/or polyethylene. For example, the lamination material 28, 29 comprises a polymer material similar to the polymer material of the extruded profile 27. According to one embodiment, the lamination material 28, 29 is a plastic material similar to the plastic material of the extruded profile 27. For example, the lamination material 28, 29 comprises a polymer material having similar or lower melting temperature than the polymer material of the extruded profile 27. According to one embodiment, the thermoplastic material of the lamination material 28, 29 has a melting point differing less than 30° C. or less than 20° C. or less than 10° C. from the melting point of the material at the surface 32, 33 of the extruded profile 27. The lamination material 28, 29 is a sheet material, which is not coextruded with the extruded profile 27. For example, the lamination material 28, 29 is a sheet of material which cannot be coextruded with the extruded profile 27. Hence, according to one embodiment, the lamination material 28, 29 is a non-coextrudable material, such as a nonwoven fabric. In the illustrated embodiment, the lamination material 28, 29 is a point bonded nonwoven fabric having intermittent bond points 44. For example, the bond points 44 form the indentations 41 or at least some of the indentations 41, wherein other indentations 41 are formed by the inherent irregular structure of the lamination material 28, 29 in areas adjacent the point bonds 44. Hence, according to one embodiment, the lamination material 28, 29 comprises a web of filaments 45, such as a web of substantially continuous and randomly deposited, molecularly oriented filaments. For example, the filaments have an average filament diameter of at least 5 microns. The web of filaments 45 of the lamination material 28, 29 is, e.g. positioned in laminar surface-to-surface relationship and united together and formed by the application of heat and pressure to thereby form the indentations 41. The bond points 44 of the nonwoven fabric are, e.g. arranged to provide a unitary structure of said web of filaments 45 having textile-like appearance and drape characteristics and having the bond points 44 integrating the web of substantially continuous filaments 45 so that said web can function as an effective load bearing constituent of the lamination material 28, 29 during straining thereof. For example, the bond points 44 of the lamination material 28, 29 occupy about 5-50% of the surface area of the web of filaments 45 and, hence, the first and/or second surface 42, 43 of the lamination material 28, 29.

A problem with known VCI sheets used as anti-rust packaging material is that it has limitations such as having a tight and flat surface. This leads to moisture in a package can condense on the surface of the VCI sheet to create and hold a thin water film layer between the flat extruded VCI sheet surface and a flat surface of a metal product being packed. In that way that the rust attack increases and the VCI rust protection decreases.

The inventor of the current invention has realized, after inventive and insightful reasoning, that this problem can be mitigated by the embodiments of the invention further described below.

In one embodiment, a lamination material 28, 29 comprises a thermoplastic material with electrical static discharge (ESD) properties.

According to one embodiment, the lamination material 28, 29 is composed of an air permeable nonwoven thermoplastic material with ESD properties. For example, the lamination material 28, 29 is antistatic. For example, the lamination material 28, 29 is dissipative. For example, the lamination material 28, 29 is conductive.

According to one embodiment, the extruded profile 27 comprises a polyolefin and a volatile corrosion inhibitor agent and the lamination material 28, 29 comprises a thermoplastic material with electric discharge properties, where the lamination material also is permeable to air, which is illustrated schematically in FIG. 6 by means of the arrows A. For example, air and similar fluids can flow from a side at a first surface 42 of the lamination material 28, 29 to the opposite side at the opposite second surface 43 thereof through the lamination material 28, 29, such as substantially perpendicular through it. For example, a volatile corrosion inhibitor agent of the extruded profile 27 can flow from the extruded profile 27 through the lamination material 28, 29 such that it can reach and protect for example metal objects or electronic objects located in the vicinity thereof from corrosion.

According to one embodiment, the volatile corrosion inhibitor agent of the polymeric extruded profile 27 can flow from the extruded profile 27 through the lamination material 28, 29 such that it can reach and rust protect for example metal objects or electronic objects from corrosion and where the lamination material 28, 29 is a point bonded nonwoven fabric having filaments 45 creating an open material structure. This prevents moisture condensation from collecting and creating an obstructive water film layer on the outer surfaces of the lamination material 28, 29. Such water film layer could decrease and limit the rust protective capacity of the volatile inhibitor agent vaporing from the VCI protective extruded profile 27.

For example, by the means of the invention, such parts can be protected from corrosion by the vapouring of the VCI agent from the extruded profile 27 through the permeable lamination material 28, 29 at the same time as such parts are protected from static electricity by the electrical static discharge characteristics of the lamination material 28, 29.

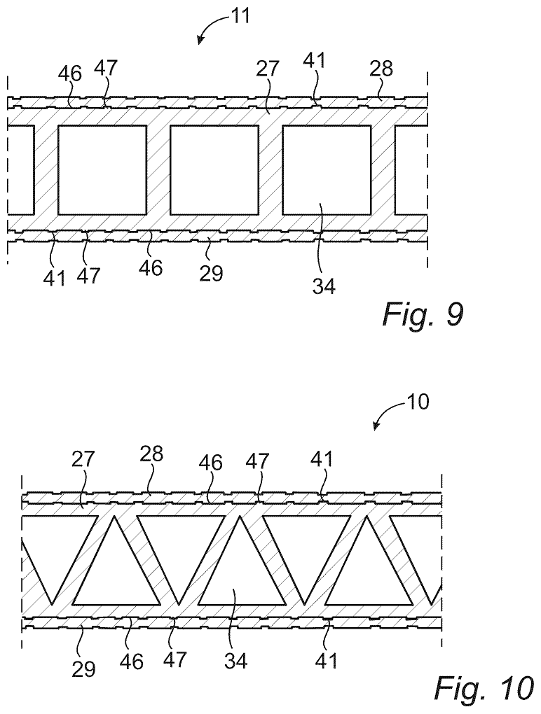

With reference to FIGS. 9 and 10 a section of the multiple layer material 11 along the line B-B in FIG. 1 is illustrated according to a few embodiment examples. The multiple layer material 11 comprises the extruded profile 27 provided with at least the first lamination material 28. In the illustrated embodiments the multiple layer material 11 comprises the first lamination material 28 and the second lamination material 29, wherein the first lamination material 27 is fastened to one surface 32 of the extruded profile 27, and the second lamination material is fastened to the opposite surface 33 of the extruded profile 27. In the illustrated embodiment, the first and second lamination materials 28, 29 are both air permeable materials with the indentations 41, such as air permeable nonwoven fabrics. Alternatively, only one of the first and second lamination materials 28, 29 is air permeable and arranged with the indentations 41, wherein the other of the first and second lamination materials 28, 29 is a different type of lamination material.

The lamination material 28, 29 is fastened directly to the extruded profile 27 by a melt bond 46 in combination with a mechanical bond 47. Hence, the lamination material 28, 29 is arranged in contact with the extruded profile 27 and fastened to the extruded profile 27 without glue or any additional adhesive. For example, the lamination material 28, 29 is adhered to the extruded profile 27 by the surface 32, 33 of the extruded profile 27 still being soft or melted from the extrusion process and/or the surface of the lamination material 27, 28 being softened or melted by the extruded profile 27 still being hot from the extrusion process. For example, the surface 42, 43 of the lamination material 28, 29 and the extruded profile 27 are melted together forming the melt bond 46 between them, wherein the melt bond 46 is formed by heat from the extrusion process or heat from the extrusion process in combination with additional heating before the calibration. Alternatively, at least one of the surfaces 33, 34, 42, 43 of the lamination material 28, 29 and the extruded profile 27 is softened or melted by heat from the extrusion process or heat from the extrusion process in combination with additional heating, wherein said surface is deformed when the lamination materials 28, 29 are applied to the extruded profile to form the mechanical bond 47 between them. Hence, the melt bond 46 is formed by at least partially melting the material of the surface 32, 33 of the extruded profile 27 and at least partially melting the material of the surface 42, 43 of the lamination material 28, 29 and melting only a part of the thickness of the lamination material 28, 29, before or after bringing said surfaces together. The mechanical bond 47 is formed by that the material at the at least partially melted surface 32, 33 of the extruded profile 27 is brought into the indentations 41 of the lamination material 28, 29, wherein it is hardened. Melting of the material of the surface 42, 43 of the lamination material 28, 29 and the part of the thickness thereof may result in that the air permeability of the lamination material 28, 29 is lost. Hence, the lamination material 28, 29 is permeable to air at least before it is adhered to the extruded profile 27. After adhesion to the extruded profile 27, the air permeability of the lamination material 28, 29 is lost at least partly.

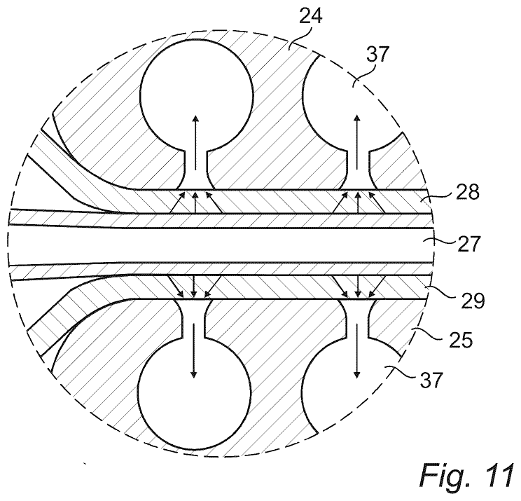

With reference to FIG. 11, a part of the device 10 depicted by the dashed circle in FIG. 3 is illustrated schematically more in detail. According to the illustrated embodiment the calibrator 14 comprises the vacuum channels 37 for pulling the multiple layer material 11 towards the top and bottom calibrator plates 24, 25, respectively, as illustrated by means of the schematic arrows in FIG. 11. As the lamination materials 28, 29 are permeable to air, the extruded profile 27 is pulled towards the calibration plates 24, 25 so that the extruded profile 27 pushes the lamination materials 28, 29 towards said calibration plates 24, 25. Also, the melted material at the surface 32, 33 of the extruded profile 27 is forced into the indentations 41 of the lamination material 28, 29. For example, the calibrator 14 is a dry vacuum calibrator table.

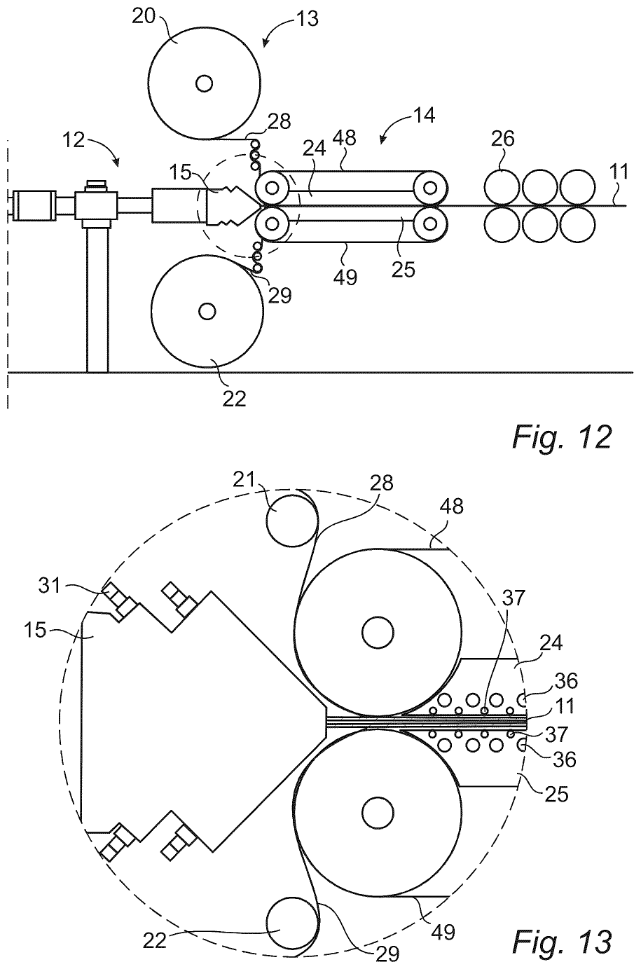

With reference to FIGS. 12 and 13 a part of the device 10 according to another alternative embodiment is illustrated. According to the embodiment of FIGS. 12 and 13 the extruder die 15 is tapered and the adjustment screws 31 are inclined backwards. The calibrator 14 according to the embodiment of FIGS. 12 and 13 comprises a top endless belt 48 and a bottom endless belt 49 arranged with a gap between them, wherein said endless belts 48, 49 are arranged for conveying the multiple layer material 11 through said gap while the multiple layer material 11 is calibrated. For example, the calibrator 14 comprises the top and bottom calibration plates 24, 25 with the cooling channels 36 and the vacuum channels 37, wherein the endless belts 48, 49 passes over the top and bottom calibration plates 24, 25. Hence, the endless belts 48, 49 are arranged for engaging the lamination materials 28, 29 of the multiple layer material 11 and conveying the multiple layer material 11 through the calibrator 14. Hence, the conveying speed of the endless belts 48, 49 correspond to the conveying speed of the lamination materials 28, 29, so that the multiple layer material 11 is conducted through the calibrator 14 without the lamination materials 28, 29 being dragged over fixed calibration plates as with the embodiments described above. For example, the endless belts 48, 49 are provided with through holes for air permeability so that the vacuum provided by the vacuum channels 37 can act on the multiple layer material 11 between the endless belts 49, 49. According to one embodiment the endless belts 48, 49 are made of metal, such as steel.

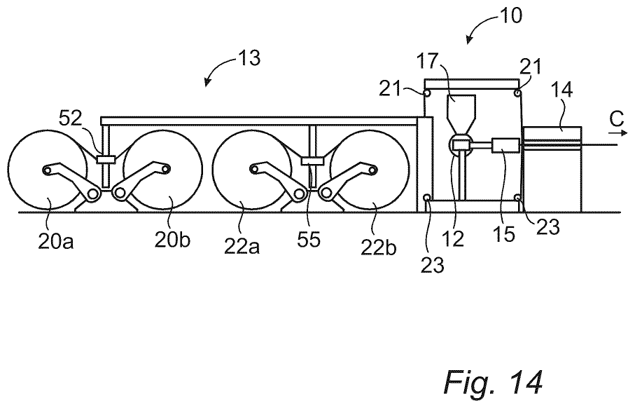

With reference to FIG. 14 the device 10 is illustrated according to another embodiment, wherein the device 10 comprises the extruder 12, the calibrator 14 and the lamination material providing means 13. The extruder die 15 is arranged with a small gap to the calibrator 14 for providing the lamination materials 28, 29 to the extruded profile 27 before the extruded profile 27 with the lamination materials 28, 29 enter the calibrator 14 as described above. In the embodiment of FIG. 14 the lamination material providing means 13 comprises a primary first storage roll 20a and a secondary first storage roll 20b and a mechanism 52 for automatic change between the primary first storage roll 20a and the secondary first storage roll 20b when required. The lamination material providing means 13 also comprises a primary second storage roll 22a and a secondary second storage roll 22b connected to a mechanism 52 for automatic change in a similar manner. The lamination material providing means also comprises suitable guide rollers 21, 23 or similar for feeding the lamination materials 28, 29 to the extruded profile 27. Hence, the lamination material providing means 13 is arranged for automatically changing between lamination material storage rolls 20a, 20b, 22a, 22b. For example, the lamination material providing means 13 comprises a conventional automatic changeover system. In the embodiment of FIG. 14 the extruder die 15 is arranged perpendicular to the remaining parts of the extruder 12, e.g. including the extruder screw, optionally the motor 16 and optionally the hopper 17. For example, the lamination material storage rolls 20a, 20b, 22a, 22b are aligned with the extruder die 15 and the calibrator 14 in a direction lateral to the feeding direction C. Alternatively, the extruder 12 is arranged in a straight feeding line as illustrated in FIG. 1, wherein the lamination material providing means 13 for automatic changeover between lamination material storage rolls 20a, 20b, 22a, 22b is displaced to the calibrator 14 in the lateral direction.

1. A multiple layer material (11) comprising an extruded profile (27) and at least one lamination material (28, 29), wherein the extruded profile (27) comprises at least one polymer material and is formed with a top surface (32) and a bottom surface (33), wherein the lamination material (28, 29) is adhered to at least one of the top and bottom surfaces (32, 33) of the extruded profile (27) to form the multiple layer material (11), characterised in that the lamination material (28, 29) is formed with a structure with indentations (41), and the multiple layer material (11) comprises a melt bond (46) and a mechanical bond (47) between the extruded profile (27) and the lamination material (28, 29), wherein said melt bond (46) is formed by at least partially melting the material of the surface (32, 33) of the extruded profile (27) and at least partially melting only a part of the thickness of the lamination material (28, 29), wherein said mechanical bond (47) is formed by that the material at the at least partially melted surface (32, 33) of the extruded profile (27) is brought into the indentations (41) of the lamination material (28, 29), and wherein the lamination material (28, 29), at least before it is adhered to the extruded profile (27), is permeable to air.

2. A multiple layer material according to claim 1, wherein the extruded profile (27) comprises a volatile corrosion inhibitor.

3. A multiple layer material according to claim 1, wherein the lamination material (28, 29) is a nonwoven fabric.

4. A multiple layer material according to claim 1, wherein the lamination material (28, 29) is a point bonded nonwoven fabric.

5. A multiple layer material according to claim 1, wherein the lamination material (28, 29) comprises electrical static discharge properties.

6. A multiple layer material according to claim 1, wherein the lamination material (28, 29) is a nonwoven fabric comprising a web of substantially continuous and randomly deposited, molecularly oriented filaments of a thermoplastic polymer having an average filament diameter of at least 5 microns.

7. A multiple layer material according to claim 1, wherein the filament web of the lamination material (28, 29) is positioned in laminar surface-to-surface relationship and united together and formed by the application of heat and pressure to thereby form the indentations.

8. A multiple layer material according to claim 1, wherein intermittent bond points of the nonwoven fabric provide a unitary structure of said web having textile-like appearance and drape characteristics and having the intermittent bond points integrating the web of substantially continuous filaments so that said web can function as an effective load bearing constituent of the lamination material during straining thereof.

9. A multiple layer material according to claim 1, wherein intermittent bond points of the lamination material occupy about 5-50% of the surface area of said web and lamination material (28, 29).

10. A multiple layer material according to claim 1, wherein filaments of the lamination material (28, 29) has a melting point differing less than 30° C. from the melting point of the material at the surface (32, 33) of the extruded profile (27).

11. A packaging material comprising a multiple layer material according to claim 1.

12. A process for continuously producing a multiple layer material (11) containing at least one polymer material, comprising the steps of
a) by means of an extruder die (15) extruding a profile having a top surface (32) and a bottom surface (33),
b) feeding the extruded profile (27) from the extruder die (15) towards a calibrator (14),
c) applying an air permeable lamination material (28, 29) with indentations (41) onto at least one of said top surface and bottom surface (32, 33) of the extruded profile (27) before entering the calibrator (14), and
d) bringing an at least partially melted surface material of the extruded profile (27) into the indentations (41) of the lamination material (28, 29), and thereby forming a mechanical bond (47) between the extruded profile (27) and the lamination material (28, 29), and
e) at least partially melting only a part of the thickness of the lamination material (28, 29) and thereby forming a melt bond (46) between the extruded profile (27) and the lamination material (28, 29).

13. A process according to claim 12, including the step of applying the lamination material (28, 29) to the extruded profile (27) wherein the extruded profile (27) comprises a volatile corrosion inhibitor.

14. A process according to claim 12, including the step of applying the lamination material (28, 29) in the form of a nonwoven fabric comprising a thermoplastic polymer.

15. A process according to any of claim 12, including the step of applying the lamination material (28, 29) in the form of a point bonded nonwoven fabric.

16. A process according to claim 12, including the step of applying the lamination material (28, 29) to the extruded profile (27), wherein the lamination material (28, 29) comprises electrical static discharge properties.

17. A process according to claim 12, comprising the step of feeding the lamination material (28, 29) from a roll (20, 22) to a position between the extruder die (15) and the calibrator (14).

18. A process according to claim 12, comprising the step of calibrating the multiple layer material (11) by means of a vacuum calibrator.
